(19) United States
(12) Patent Application Publication
(10) Pub. No.: US 2025/0121959 A1
(43) Pub. Date: Apr. 17, 2025

(54) REUSABLE AND RECONFIGURABLE LAUNCH VEHICLE

(71) Applicant: HStar Space Transport Corporation, Los Angeles, CA (US)

(72) Inventors: Juha NIEMINEN, Los Angeles, CA (US); Adarsh RAJGURU, Los Angeles, CA (US); Nicholas ORENSTEIN, Los Angeles, CA (US); Enzo BLEZE, Los Angeles, CA (US)

(21) Appl. No.: 18/907,822

(22) Filed: Oct. 7, 2024

Related U.S. Application Data
(60) Provisional application No. 63/543,742, filed on Oct. 12, 2023.

(51) Int. Cl. B64G 1/40; B64G 1/00; B64G 1/24

(52) U.S. Cl. CPC B64G 1/401; B64G 1/006; B64G 1/244

(57) ABSTRACT

Implementations of the disclosed subject matter may provide an adaptive thrust structure for a space launch vehicle that may include an interface block that is fluidically coupled to a fuel supply, a fuel manifold, an oxidizer supply, and an oxidizer manifold. A first adapter plate may be coupled to a first engine assembly. First adapter lines may be fluidically coupled to the first engine assembly and the interface block, via the first adapter plate. A second engine assembly, second adapter lines, and a second adapter plate are capable of replacing the first engine assembly, first adapter lines, and first adapter plate. Implementations of the disclosed subject matter may provide a reusable and reconfigurable launch vehicle that may include a reusable second stage, and a reusable and reconfigurable transporter having a plurality of zones that are configurable to transport cargo, one or more passengers, and/or one or more satellites.

### CROSS-REFERENCE TO RELATED APPLICATIONS

This application claims priority to U.S. Application Ser. No. 63/543,742, filed Oct. 12, 2023, the disclosure of which is incorporated by reference in its entirety.

### BACKGROUND

Current space launch vehicles are typically not fully reusable. Some space launch vehicles use solid rocket boosters and external fuel tanks that are discarded on every flight, and some have at least one stage that is discarded after every flight. Other space launch vehicles have reusable portions that require heat shield refurbishment after each flight. Some current space launch vehicles are limited in the types of missions that they can perform, such as being able to transport passengers while being unable to also transport and deploy satellites. Other current launch vehicles can be used for different missions, but have a stage that must be specifically built for a particular mission.

### BRIEF SUMMARY

Implementations of the disclosed subject matter may provide an adaptive thrust structure for a space launch vehicle. The adaptive thrust structure may include a fuel supply fluidically coupled to a fuel manifold, and an oxidizer supply fluidically coupled to an oxidizer manifold. An interface block may be fluidically coupled to the fuel supply, the fuel manifold, the oxidizer supply, and the oxidizer manifold. The adaptive thrust structure may include a first adapter plate coupled to the first engine assembly, where the first engine assembly is configured to provide thrust for the space launch vehicle. The adaptive thrust structure may include first adapter lines fluidically coupled to the first engine assembly and the interface block, via the first adapter plate. A second engine assembly may be capable of replacing the first engine assembly, second adapter lines may be configured to be fluidically coupled to the second engine assembly and may be capable of replacing the first adapter lines, and a second adapter plate may be configured to be coupled to the second engine assembly and may be capable of replacing the first adapter plate.

Implementations of the disclosed subject matter may provide a system having a reusable and reconfigurable launch vehicle that may include a reusable second stage having a first thrust structure coupled to a first engine assembly that is configured to provide thrust for the launch vehicle, and at least one fuel supply and at least one oxidizer supply fluidically coupled to the first engine assembly, where the reusable second stage is capable of being removably coupled to a reusable first stage. The reusable and reconfigurable launch vehicle may include a reusable and reconfigurable transporter configured to be removably coupled to the reusable second stage, where the reusable and reconfigurable transporter has a plurality of zones that are configurable to transport cargo, one or more passengers, and/or one or more satellites.

Additional features, advantages, and implementations of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example arrangement of stages and payload zones of a launch vehicle, including a reusable first stage, a reusable second stage, and a reusable and reconfigurable transporter according to implementations of the disclosed subject matter.

FIG. 2 shows an example reusable second stage of the launch vehicle of FIG. 1 according to implementations of the disclosed subject matter.

FIGS. 3A-3E shows a first variation of a first example architecture of the reusable second stage and the reusable and reconfigurable transporter according to implementations of the disclosed subject matter.

FIG. 4 shows a second variation of the reusable second stage and the reusable and reconfigurable transporter of the first example architecture according to implementations of the disclosed subject matter.

FIG. 5 shows a third variation of the reusable second stage and the reusable and reconfigurable transporter of the first example architecture according to implementations of the disclosed subject matter.

FIGS. 6A-6D show a first variation of a second example architecture of the reusable second stage and the reusable and reconfigurable transporter according to implementations of the disclosed subject matter.

FIGS. 7A-7D show a second variation of the reusable second stage and the reusable and reconfigurable transporter of a second example architecture according to implementations of the disclosed subject matter.

FIGS. 8A-8F show a third variation of the reusable second stage and the reusable and reconfigurable transporter of a second example architecture according to implementations of the disclosed subject matter.

FIGS. 9A-9J show a third example architecture of the reusable second stage and the reusable and reconfigurable transporter according to implementations of the disclosed subject matter.

FIGS. 10A-10B show a re-entry configuration for the reusable second stage and the reusable and reconfigurable transporter for the third example architecture of FIGS. 9A-9J according to implementations of the disclosed subject matter.

FIGS. 11A-11G show an example adaptive thrust system including an adaptive thrust structure for a launch vehicle according to implementations of the disclosed subject matter.

FIGS. 12A-12C shows an example spaceship trajectories according to implementations of the disclosed subject matter.

### DETAILED DESCRIPTION

Implementations of the disclosed subject matter provide a launch vehicle system including a fully reusable second stage that is coupled to an interchangeable modular transporter, which may be a reusable and reconfigurable transporter. The reusable second stage and the reusable and reconfigurable transporter may increase efficiency and flexibility of space transportation over present space transportation system. The reusable second stage may be configured to have complete reusability, allowing it to return to a launch site or other destination for multiple uses without needing refurbishment. The reusable second stage may be configured to be coupled to different configurations of the reusable and reconfigurable transporter, allowing for different space flight missions (e.g., transporting passengers, cargo to a space station and/or other spaceships, and/or launching one or more satellites). The reusable second stage of the disclosed subject matter may provide a cost-effective system for deploying payloads in orbit. The reusable and reconfigurable transporter may be interchangeable with other reusable and reconfigurable transporters. The different reusable and reconfigurable transporters may be configured to carry a variety of payloads, including human passengers, one or more satellites (e.g., which may be deployed during a spaceflight mission), and/or cargo, thus making the launch system adaptable to a range of mission profiles. The transporter may be reusable, thus allowing it to return to a launch site or to travel to another destination for multiple uses without needing refurbishment, either by being coupled to the reusable second stage or independently from the reusable second stage.

Implementations of the disclosed subject matter may provide different arrangements of the reusable second stage and the reusable and reconfigurable transporter. The different arrangements described herein include an interchangeable reusable and reconfigurable transporter. The reusable and reconfigurable transporter having a first configuration may be swapped with a reusable and reconfigurable transporter having a second configuration, third configuration, or the like while the reusable transporter is on the ground. That is, either the first configuration or the second configuration, third configuration, or the like of the reusable and reconfigurable transporter may be coupled to the reusable transporter. In some implementations, the reusable and reconfigurable transporter may be configured to remain coupled to the reusable second stage during missions, but may be swappable with a different reusable and reconfigurable transporter on the ground.

The reusable and reconfigurable transporter may include one or more zones to transport one or more passengers, one or more satellites, and/or cargo. One example zone may be an unpressurized volume that may be configured to carry one or more satellites and/or cargo. Another example zone may be configured as a pressurized payload volume within the transporter module, suitable for transporting humans, animals, and/or plants. In some implementations, sensitive cargo may be transported in a pressurized environment.

The reusable and reconfigurable transporter may include a satellite payload adapter that may be configured to accommodate the one or more satellites being transported. The one or more satellites may be stored in an unpressurized zone. In some implementations, the satellite payload adapter may be adjustable to fit one or more sizes of satellites. In some implementations, a ring arrangement (e.g., an EELV (evolved expendable launch vehicle) secondary payload adapter (ESPA) ring) may be used to hold one or more satellites for deployment. The adjustable payload adapter may help maximize the usable space in the unpressurized cargo hold. The volume-efficient payload adapters may increase the total number of unique satellites that can be carried.

In some implementations, the reusable and reconfigurable transporter may detach and reattach to the reusable second stage as needed during operations in space. In some implementations, the reusable and reconfigurable transporter may have a propulsion system configured to provide thrust. The reusable and reconfigurable transporter may use the propulsion system to serve as a docking vehicle to space stations, as a return vehicle from space stations, and/or as an emergency escape vehicle during an emergency abort operation.

In some implementations of the disclosed subject matter, the reusable second stage coupled to the reusable and reconfigurable transporter may be configured to travel from a planetary body surface, from a planetary satellite surface, or from an asteroid surface to any orbit. The payload that may include one or more deployable satellites, passengers, and/or cargo may return one or more portions of the payload to the planetary surface from which the launch was initiated, or from another planetary surface, planetary satellite surface, or asteroid surface.

The reusable and reconfigurable transporter may be configured to dock with space stations by using an international docking adapter (IDA) or other suitable docking adapter. A pressurize region and/or zone of the reusable and reconfigurable transporter may open to the docking adapter by using a door hatch or by using an iris-style hatch, which may offer a more efficient alternative to traditional door hatches used in other spacecraft and space stations.

To enhance structural integrity, the reusable second stage and/or the reusable and reconfigurable transporter may be constructed using electron beam welding, which may increase the strength of structure across the wide range of operating temperatures encountered during flight.

The launch vehicle (e.g., that may include the reusable second stage and/or the reusable and reconfigurable transporter) may be operated from spaceports equipped with universal assembly buildings, vehicle transporters, and/or launch pads that may be configured to accommodate vehicles of different sizes.

Implementations of the disclosed subject matter described throughout provide a versatile, reusable, and/or modular launch vehicle system that provides operational flexibility in space missions and reduces costs.

Implementations of the disclosed subject matter may include an adaptive thrust structure that may be included with the reusable second stage. The adaptive thrust structure may be configured to accommodate different engines (e.g., methane/liquid oxygen engines, or other types of engines) from a plurality of manufacturers. That is, the adaptive thrust structure may provide compatibility with different propulsion systems. Including the adaptive thrust structure with the reusable second stage may increase a launch vehicle's adaptability and may extends its operational lifespan by making it compatible with more advanced engines that may become available.

Implementations of the disclosed subject matter may provide an adaptive thrust structure, which may be the mechanical assembly of the reusable second stage described throughout that engines are mounted on. The adaptive thrust structure may transmit the thrust force produced by the engines into the walls of the reusable second stage without buckling the whole stage and/or vehicle. The adaptive thrust structure of the disclosed subject matter may provide adaptive mechanical, electrical, and/or fluid interfaces that are reconfigurable to facilitate using different engines (e.g., methane/liquid oxygen engines) from different manufacturers. In some implementations, the launch vehicle may operate with any grade of liquefied natural gas (including pure methane), providing flexibility in fuel choices for the adaptive thrust structure.

The adaptive thrust structure improves upon current thrust structures for launch vehicles that are built around one engine design, which make it difficult to accommodate a change later if needed. Implementations of the disclosed subject matter allow for the reusable second stage and the engines to be separately designed, and then combined as part of the adaptive thrust structure as needed for one or more space missions.

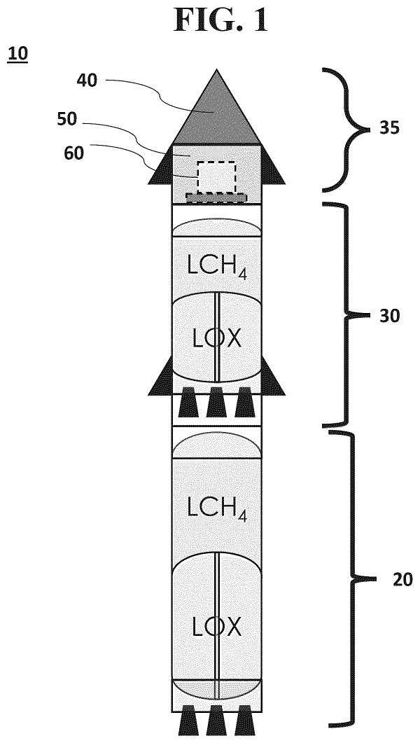

FIG. 1 shows an example arrangement of stages and payload zones of a launch vehicle 10, including a reusable first stage 20, a reusable second stage 30, and a reusable and reconfigurable transporter 35 according to implementations of the disclosed subject matter. The reusable first stage 20 may be used during launch of the launch vehicle 10, and may be separated from reusable second stage 30 after launch. Reusable second stage 30 may provide thrust to move the reusable and reconfigurable transporter 35 into, for example, a payload deployment location after separation from the reusable first stage 20. In some implementations, the reusable second stage 30 may be separable from the reusable and reconfigurable transporter 35. Zone 40 may be configured to transport passengers and/or cargo into space. Zone 50 of the reusable and reconfigurable transporter 35 may be configured to transport cargo and/or one or more satellites 60 into space.

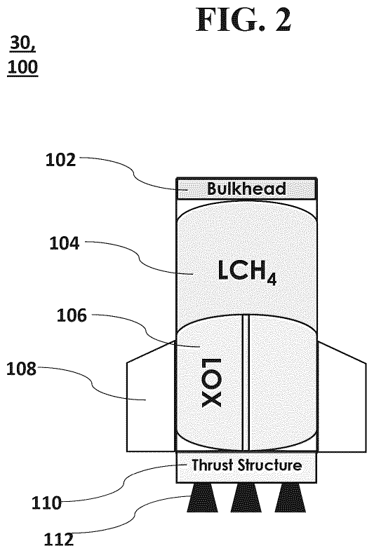

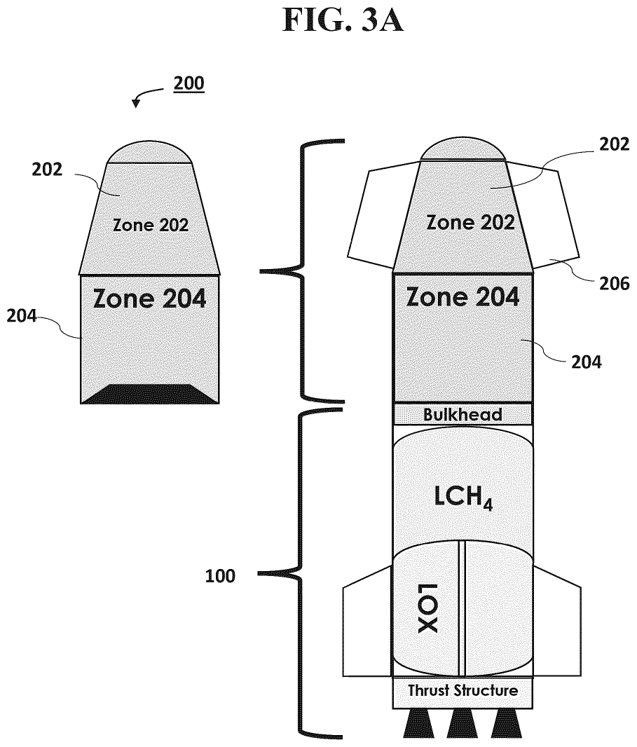

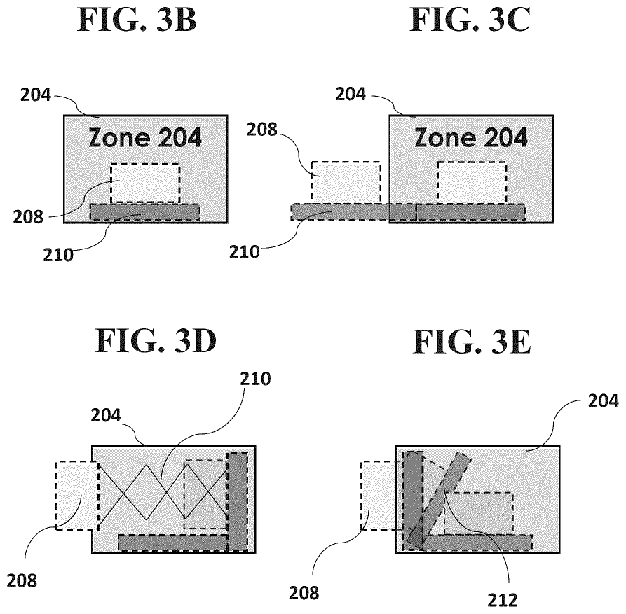

FIG. 2 shows an example reusable second stage 100 of the launch vehicle 10, which may be similar to and/or the same as the reusable second stage 30 of FIG. 1 according to implementations of the disclosed subject matter. Bulkhead 102 may be configured to be removably coupled to a reusable and reconfigurable transporter, such as reusable and reconfigurable transporters 200, 220, and 240, shown in FIGS. 3A-5. Fuel 104 may be LCH4 (i.e., liquid methane) or any other suitable fuel, and oxidizer 106 may be liquid oxygen (LOX) or any other suitable oxidizer which may be used as an oxidizer of a selected fuel. Fuel 104 and oxidizer 106 may be provided to engines 112 mounted on a thrust structure 110 to generate thrust for the reusable second stage 100. Fins 108 may be disposed on the reusable second stage 100 to maintain stability and/or direction during at least a portion of flight.

FIGS. 3A-3E shows a first variation of a first example architecture of the reusable second stage 100 and a reusable and reconfigurable transporter 200 according to implementations of the disclosed subject matter. The reusable and reconfigurable transporter 200 may be removably coupled to the above-described reusable second stage 100. As shown in FIG. 3A, the reusable and reconfigurable transporter 200 may include zone 202 which may be configured to transport one or more satellites having a first size, and zone 204 may be configured to transport one or more satellites having a second size, where the first size of the satellites is smaller than the second size. In some implementations, zone 202 and/or 204 may be unpressurized.

FIGS. 3B-3C shows zone 204 configured to transport one or more satellites 208. The satellites 208 may be disposed on rail system 210, where rail system 210 may be moved to deploy the one or more satellites 208. In some implementations, zone 204 may have a rotating or sliding door that is configured to allow the rail system 210 to deploy the one or more satellites 208. FIG. 3D shows that, in some implementations, zone 204 may have a scissor lift 210 to deploy the one or more satellites 208 from the rotating or sliding door. FIG. 3E shows a payload adapter 212 that may be configured to deploy the one or more satellites 208 by extending the payload from the rotating or sliding door in some implementations.

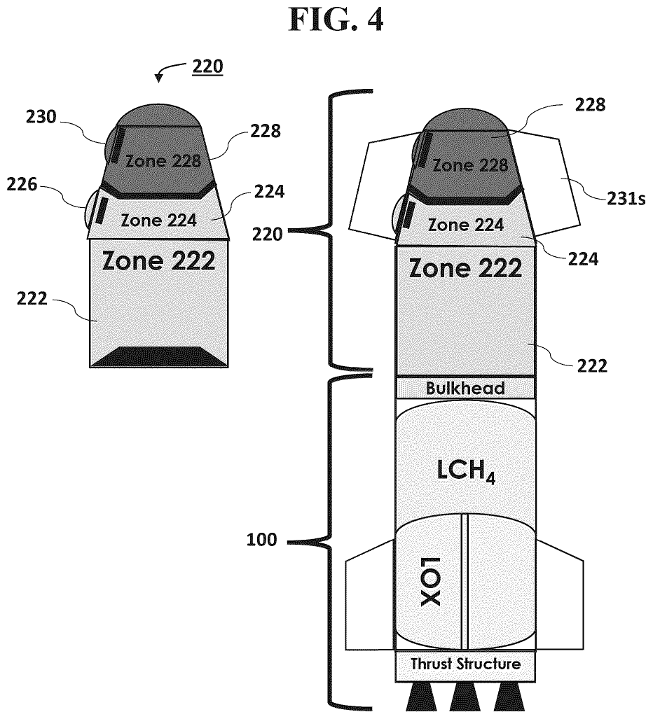

FIG. 4 shows a second variation of a reusable and reconfigurable transporter 220 of the first example architecture that may be removably coupled to the reusable second stage 100 according to implementations of the disclosed subject matter. Zone 222 of the reusable and reconfigurable transporter 220 may be configured to transport one or more satellites having the second size as described above to be deployed (e.g., via a sliding or rotating door), and zone 224 may be configured to transport one or more satellites having the first size to be deployed via door 226 (e.g., an unpressurized cargo bay door) as described above. Zone 222 and/or zone 224 may be unpressurized. Zone 228 may be configured to transport cargo, such as cargo for a space station. The cargo may be accessible via a docking adapter 230, which may be an international docking adapter (IDA) or the like that may be configured to interface and/or couple to the space station. The reusable and reconfigurable transporter 220 may have nose fins 231 to maintain stability and/or directionality during at least a portion of flight.

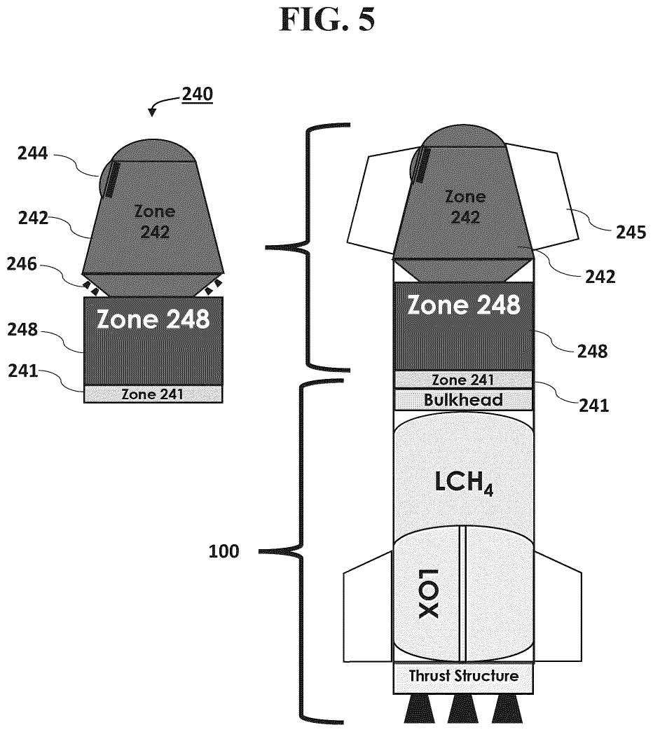

FIG. 5 shows a third variation of a reusable and reconfigurable transporter 240 of the first example architecture that may be removably coupled to the reusable second stage 100 according to implementations of the disclosed subject matter. The reusable and reconfigurable transporter 240 may include zone 241 that may be configured to transport and deploy one or more satellites of the first size as described above. The zone 241 may be an unpressurized zone. Zone 242 may be configured as a pressurized crew module and/or escape capsule to transport one or more passengers. Zone 242 may include a docking adapter 244 which may be an international docking adapter (IDA) or the like. Zone 242 may transport cargo, which may be provided to a space station, another spaceship, or the like when zone 242 is coupled via the docking adapter 244. In some implementations, the docking adapter 244 may be covered. Zone 242 may include engines 246 configured to provide thrust, which may be used when the zone 242 is operated as an escape capsule, or during transport of cargo to a space station and/or another spaceship. Zone 242 may include life support systems, cockpit controls, propellant tanks coupled to the engines 246. One or more of these may be used when zone 242 operates as an escape capsule, such as during a launch anomaly separation. Zone 248 may be configured to transport passengers, and may be pressurized. Zone 248 may include life support systems, in-space laboratories and/or manufacturing areas, personal quarters for passengers, and the like. Zone 242 may include fins 245 to provide stability and/or directionality during at least a portion of flight.

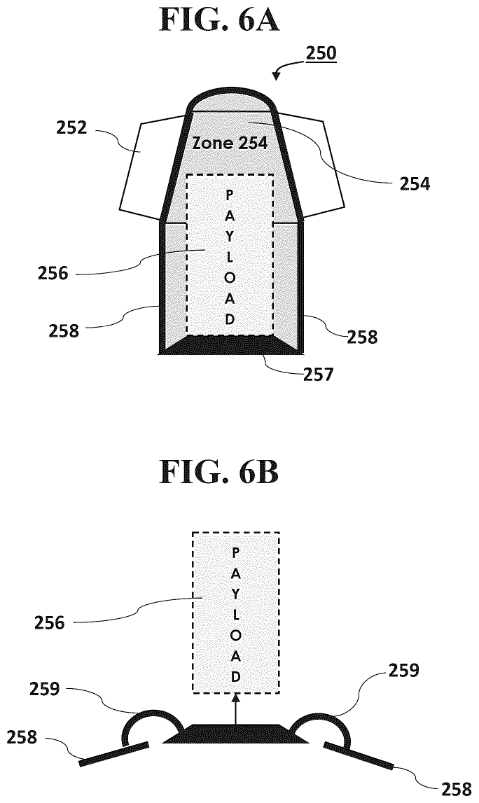

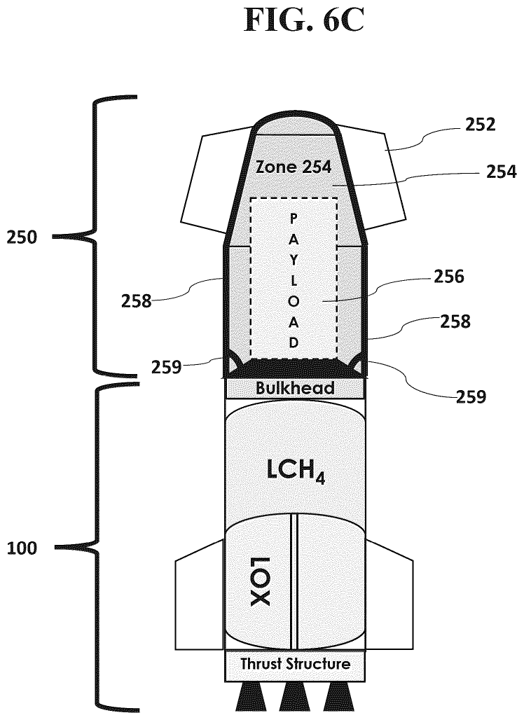

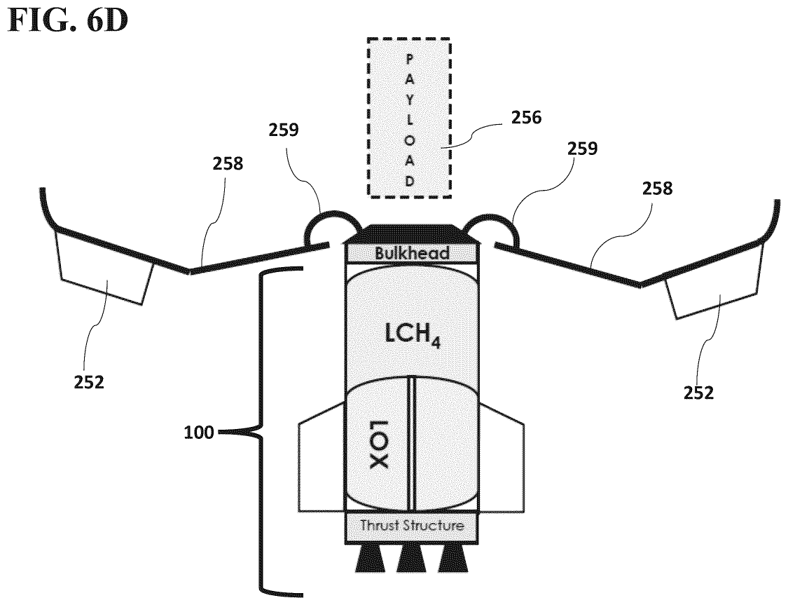

FIGS. 6A-6D show a first variation of a second example architecture of the reusable second stage 100 and a reusable and reconfigurable transporter 250 according to implementations of the disclosed subject matter. Zone 254 may be configured to transport payload 256, which may be one or more satellites. In some implementations, the one or more satellites may be coupled to at least one ring (e.g., an EELV (evolved expendable launch vehicle) secondary payload adapter (ESPA) ring, or the like). In some implementations, a plurality of rings that satellites are coupled to may be stacked together. Payload 256 may be coupled to payload adapter 257. The arrangement and/or configuration of payload adapter 257 may change based on at least a type of payload 256. In some implementations, the payload adapter may be adjustable to accommodate one or more sizes of satellites and/or other payload. In some implementations, the payload adapter 257 may be fixed on top of a tank structure. The payload adapter 257 may include a deployable mechanism that is actuated to open the deployable fairings 258 on the linkages 259. An adapter plate may be disposed on top of the payload adapter 257 to interface with the payload 256. This interface plate may include one or more release mechanisms to deploy the payload 256 from the reusable and reconfigurable transporter 250. The adapter plate may be re-configured based on a type and/or size of payload. Deployable fairings 258 may be configured to move outwardly on linkages 259 to allow for deployment of the payload 256. FIG. 6A shows the fairings 258 in a closed position, and FIG. 6B shows the fairings 258 in an open position to deploy the payload 256. Fins 252 may be attached to the fairings 258 to provide stability and/or directionality during at least a portion of flight.

FIG. 6C shows the reusable and reconfigurable transporter 250 removably coupled to the reusable second stage 100 with the fairings 258 in a closed position, and FIG. 6D shows the reusable and reconfigurable transporter 250 removably coupled to the reusable second stage 100 with the fairings 258 in an open position to deploy payload 256.

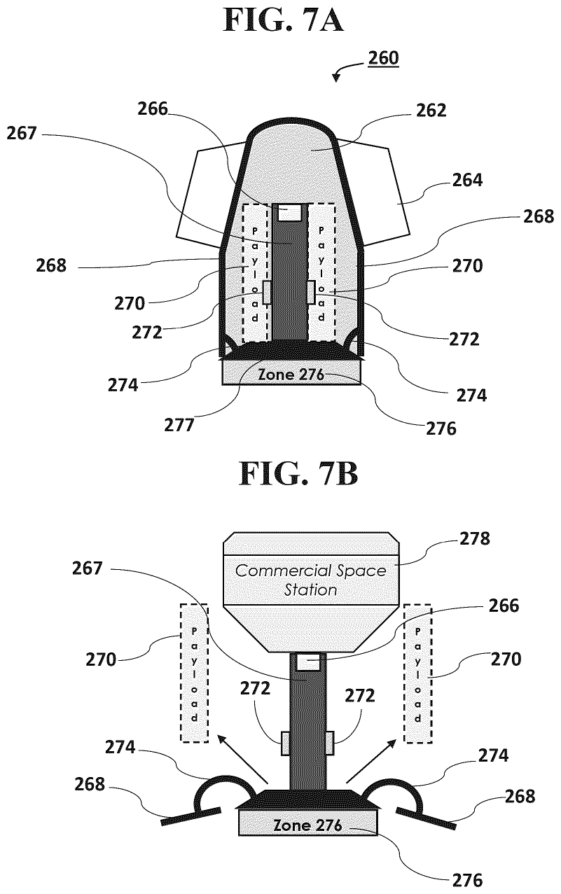

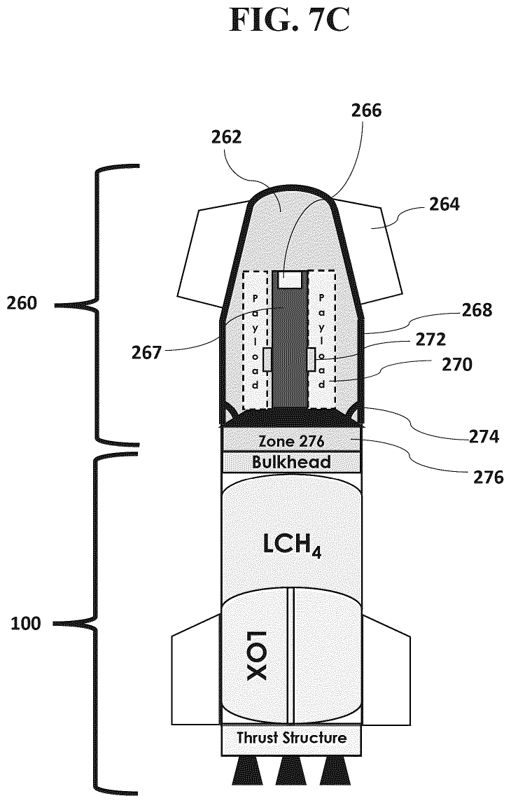

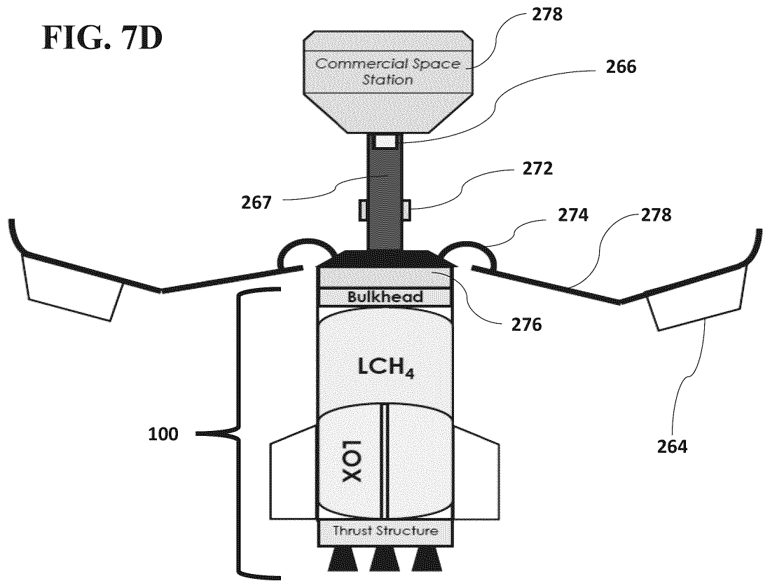

FIGS. 7A-7D show a second variation of the reusable second stage 100 and the reusable and reconfigurable transporter 260 of a second example architecture according to implementations of the disclosed subject matter. Zone 262 of the reusable and reconfigurable transporter 260 may be configured to transport one or more satellites (e.g., payload 270 shown in FIGS. 7A-7C). Deployable fairings 268 shown in FIGS. 7B-7D may be configured to move outwardly on linkages 274 to allow for deployment of the payload 270 stored in zone 262, as shown in FIG. 7B. Fins 264 may be attached to the fairings 268 to maintain stability and/or direction during at least a portion of flight. The arrangement and/or configuration of payload adapter 277 may change based on at least a type of payload 270.

Zone 267 may be configured to transport cargo in a pressurized cargo bay. Zone 267 may include a docking adapter 266 that may be configured to dock with a space station (e.g., space station 278 shown in FIGS. 7B and 7D). The cargo may be accessible via a docking adapter 266, which may be an international docking adapter (IDA) or the like that may be configured to interface and/or couple to the space station. The reusable and reconfigurable transporter 260 may deploy the one or more satellites (e.g., payload 270) stored in zone 262 before docking with a space station 278 to transfer cargo via docking adapter 266 from the zone 267, as shown in FIGS. 7B and 7D.

Zone 272 shown in FIGS. 7A-7D may be configured to transport cargo and/or small satellites in, for example, an unpressurized environment. Zone 276 shown in FIGS. 7A-7D may be configured to store one or more small satellites in, for example, an unpressurized environment.

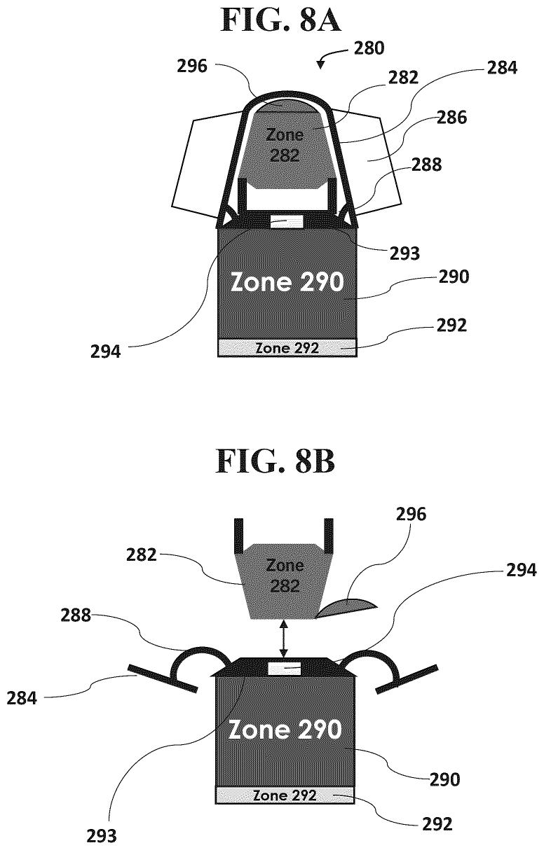

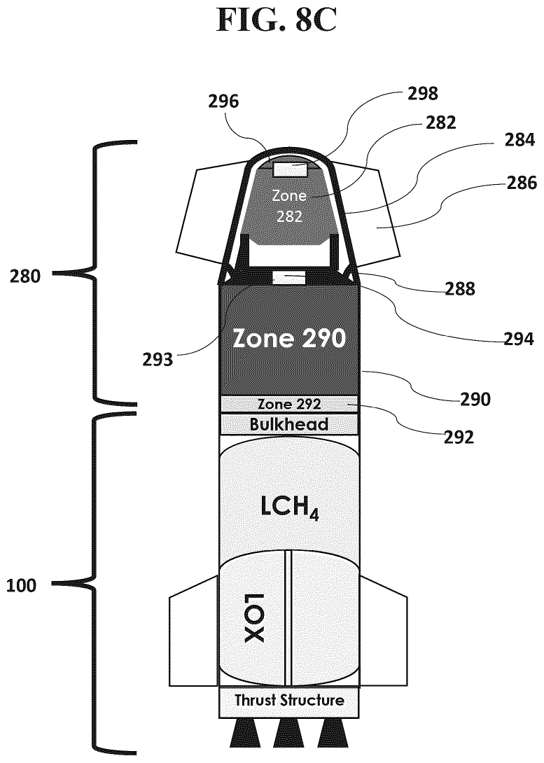

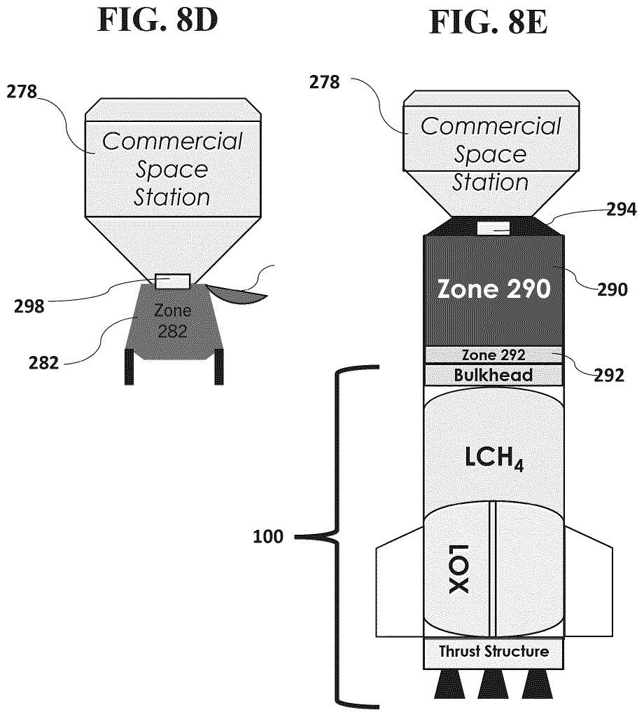

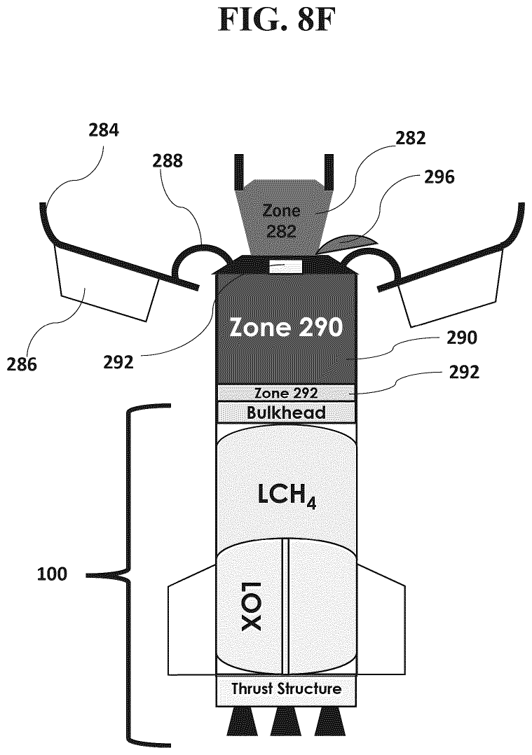

FIGS. 8A-8F show a third variation of the reusable second stage 100 and a reusable and reconfigurable transporter 280 of a second example architecture according to implementations of the disclosed subject matter. Zone 282 of the reusable and reconfigurable transporter 280 may be configured to transport one or more passengers, and may be used to shuttle passengers to and from a space station and/or serve as an emergency abort vehicle. Zone 282 may include a docking adapter 298 such as shown in FIG. 8C, which may be an international docking adapter (IDA) or the like that may be configured to interface and/or couple to a space station 278 as shown in FIG. 8D, and/or with docking interface 294 of zone 290 as shown in FIG. 8B.

Deployable fairings 284 may be coupled to linkages 288. Deployable fairings 284 may be configured to move outwardly on linkages 288 to allow for deployment of a passenger transporter of zone 282, as shown in FIG. 8B. Fins 286 may be affixed to fairings 284 of the reusable and reconfigurable transporter 280, and may be configured to provide stability and/or directionality during at least a portion of flight.

Zone 290 may be configured to store cargo and/or passengers in a pressurized environment. Zone 290 may include a payload adapter 293. The arrangement and/or configuration of payload adapter 293 may change based on at least the configuration of zone 282 that is disposed on the payload adapter 293. In some implementations, the payload adapter 293 may be adjustable to secure cargo based on the cargo type, cargo size, and the like to be transported.

Zone 290 may include a docking adapter 294 which may be an international docking adapter (IDA) or the like that may be configured to interface and/or couple to docking adapter 298 of passenger transporter of zone 282 (as shown in FIG. 8B) and/or a space station 278 (as shown in FIG. 8E). Zone 292 may be configured to transport a payload such a satellite that is of the first size (i.e., a smaller size) described above.

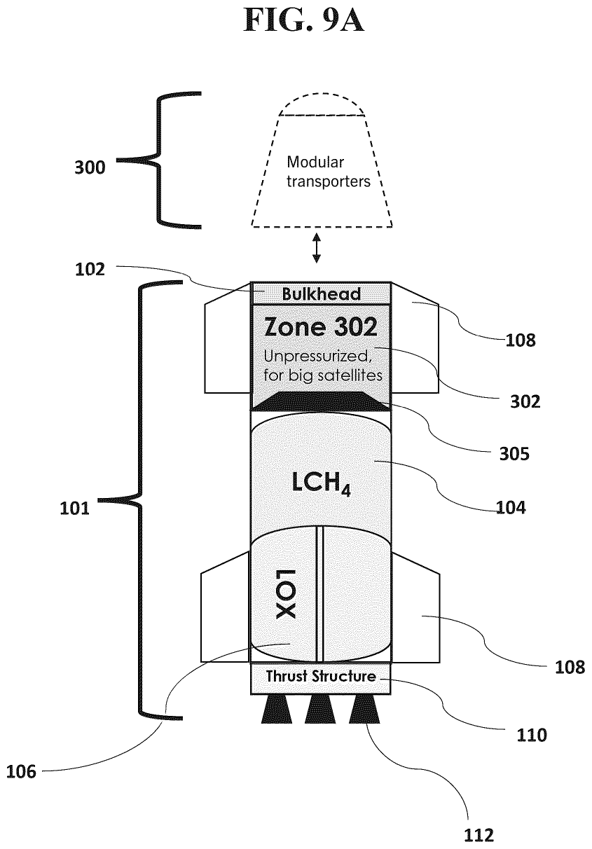

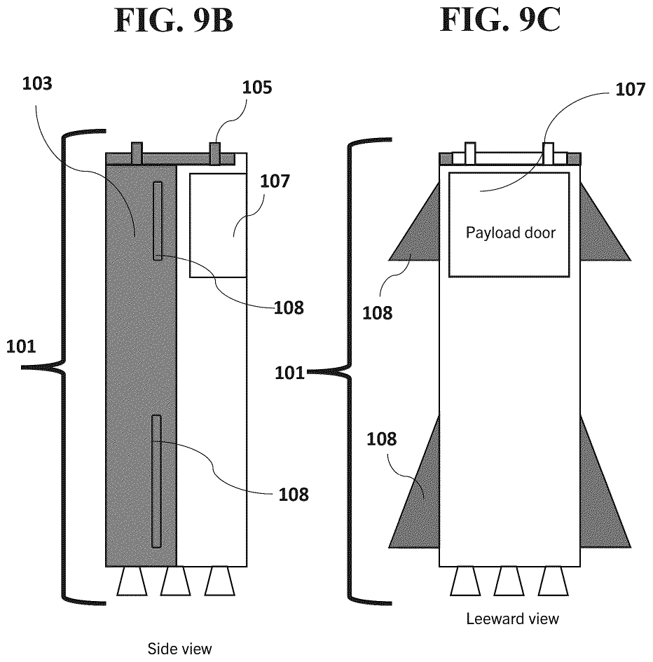

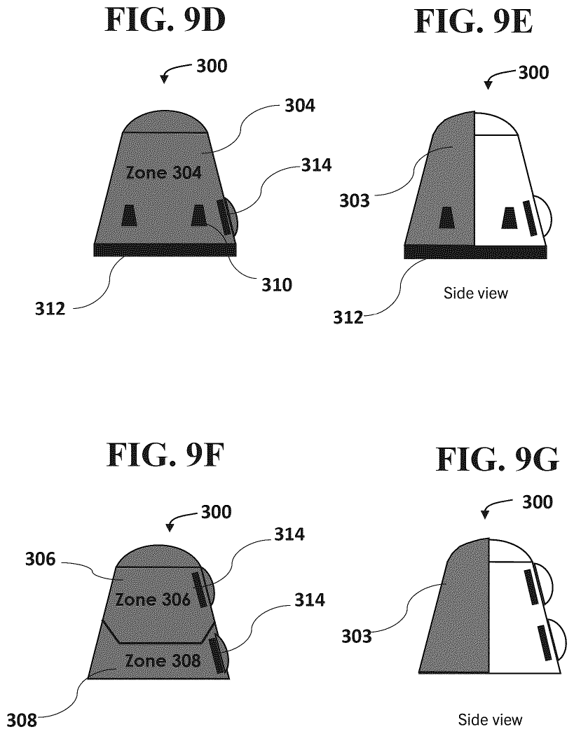

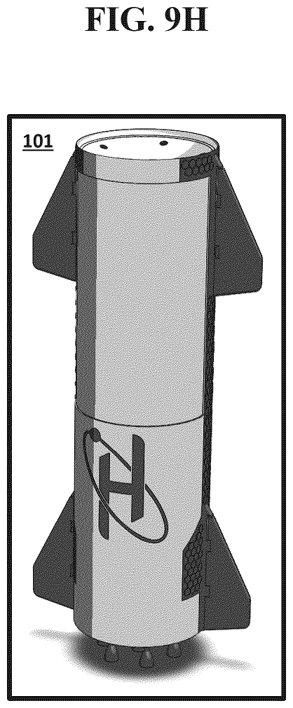

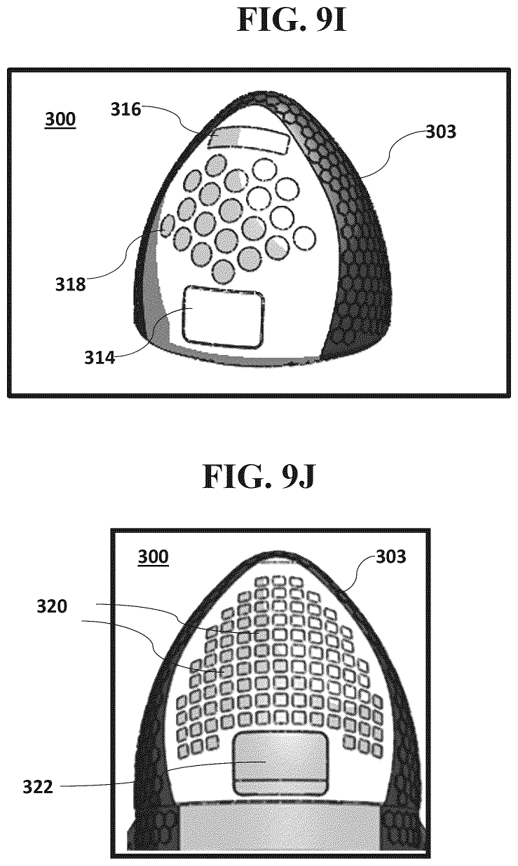

FIGS. 9A-9J show a third example architecture of a reusable second stage 101 and a reusable and reconfigurable transporter 300 according to implementations of the disclosed subject matter.

Reusable second stage 101 may be similar to reusable second stage 100 described above, but may include zone 302 that is configured to transport one or more satellites having the second size (i.e., larger size) as described above. The zone 302 may include a payload adapter 305. The arrangement and/or configuration of payload adapter 305 may change based on the type of satellite or payload to be stored in zone 302 for transport and/or deployment. The zone 302 may be unpressurized. Bulkhead 102 may be disposed over the zone 302, and may be configured to be removably coupled to a reusable and reconfigurable transporter, such as reusable and reconfigurable transporter 300 as shown in FIGS. 9A, 9D-9G, and 9I-9J.

As shown in FIG. 9B, reusable second stage 101 may include radiative heat shield 103 that may be configured to protect the reusable second stage 101 from overheating by at least dissipating and/or reflecting heat caused by re-entry into the Earth's atmosphere and/or any planetary body with an atmosphere. Although the radiative heat shield 103 is shown in the implementation shown in FIG. 9B, the radiative heat shield may be included in one or more of the implementations described throughout, and, for example, as shown in at least FIGS. 1, 2, 3A, 4-8C, 8F, and 10A-10B. As shown in FIGS. 9B-9C, latch mechanism 105 may be configured to removably couple the reusable second stage 101 to the reusable and reconfigurable transporter 300. Payload door 107 may be configured to open to deploy the one or more satellites being transported in zone 302, and close when the one or more satellites have been deployed. As shown in FIGS. 9A-9C, the reusable second stage 101 may have fins 108 that are configured to maintain stability and/or direction during at least a portion of flight. FIG. 9B shows a side view of the reusable second stage 101, FIG. 9C shows a leeward view of the reusable second stage 101, and FIG. 9H shows another view of the reusable second stage 101.

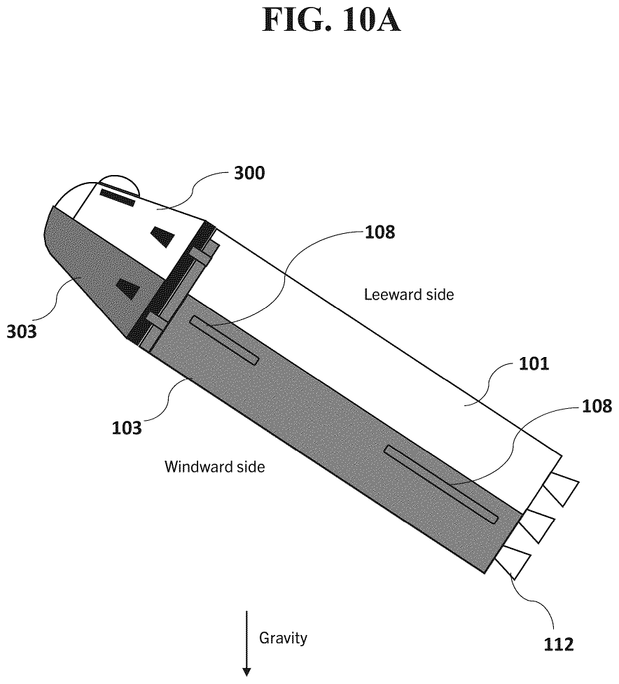

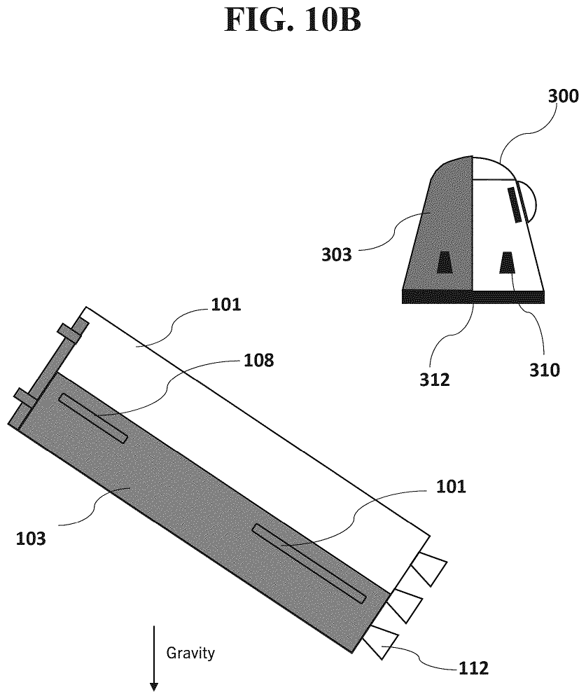

FIGS. 9D-9E show different views of an example configuration of reusable and reconfigurable transporter 300 that may be coupled to reusable second stage 101. Reusable and reconfigurable transporter 300 may include zone 304 which may be configured to transport one or more passengers. Zone 304 may be pressurized. The reusable and reconfigurable transporter 300 may have a radiative head shield 303 disposed on a side surface of the reusable and reconfigurable transporter 300, and may include a radiative or ablative heat shield 312 disposed on a bottom surface of the reusable and reconfigurable transporter 300. Heat shield 303 and/or heat shield 312 may be configured to protect the reusable and reconfigurable transporter 300 from overheating by at least dissipating and/or reflecting heat caused by re-entry into the Earth's atmosphere and/or any planetary body with an atmosphere. Heat shield 303 and/or heat shield 312 may be included in any of the implementations described throughout, and, for example, shown in at least FIGS. 1-8F and 10A-10B. The reusable and reconfigurable transporter 300 may be configured with propulsion system 310, which may be used to provide thrust when an escape operation of the reusable and reconfigurable transporter 300 from the reusable second stage 101 is needed, and/or may be used to orient the reusable and reconfigurable transporter 300 during re-entry, as described below in connection with FIG. 10B. The propulsion system 310 may be used by the reusable and reconfigurable transporter 300 to travel to a space station to deliver passengers and/or cargo. The reusable and reconfigurable transporter 300 may have a docking adapter 314, which may include a cover, and may be an international docking adapter (IDA) or the like that may be configured to interface and/or couple to a space station and/or a spaceship.

FIGS. 9F-9G show different views of an example configuration of reusable and reconfigurable transporter 300 that may be coupled to reusable second stage 101. The reusable and reconfigurable transporter 300 may include zone 306, which may be configured to transport cargo in a pressurized environment. Zone 308 may be configured to transport cargo and/or one or more satellites having a first size (i.e., smaller size), where the zone 308 may be unpressurized. Zone 306 and zone 308 may include docking adapter 314, which may include a cover and may be an international docking adapter (IDA) or the like that may be configured to interface and/or couple to a space station and/or a spaceship. In some implementations, the docking adapter 314 of zone 308 may include an access door that is configured to open for the deployment of one or more satellites.

Reusable and reconfigurable transporter 300 shown in FIG. 9I may be configured to have heat shield 303 to protect the reusable and reconfigurable transporter 300 from overheating. The reusable and reconfigurable transporter 300 may include windows 316 and/or 318 for the passengers. For example, window 316 may be a cockpit and/or crew window, and window 318 may be windows for passenger cabins. Docking adapter 314 may be configured as an access door with a docking adapter (e.g., an international docking adapter). The reusable and reconfigurable transporter 300 shown in FIG. 9I may be configured with at least one environmental control and life support system (ECLSS) to support the one or more passengers. For example, the reusable and reconfigurable transporter 300 may be configured to support more than 5, more than 10, and/or more than 15 humans for two weeks (e.g., with 100% margin), such as in a lower earth orbit (LEO).

Reusable and reconfigurable transporter 300 shown in FIG. 9J may be configured to transport cargo and/or one or more satellites having the first size as described above (i.e., a smaller size). Satellite dispenser 320 may be openings to deploy one or more satellites. The satellites and/or cargo may be stored in an unpressurized environment. In some implementations, the deployment system for the small satellites may be a CubeSat 1U form factor or similar form factor. In some implementations, satellite dispenser 320 may be configured with rapid-integration satellite deployment racks to deploy one or more satellites. Access door 322 may be configured with a docking adapter (e.g., an international docking adapter or the like) that may be coupled to a space station. For example, when a space station is coupled to the access door 322, a robotic arm of space station may extract cargo from the reusable and reconfigurable transporter 300.

FIGS. 10A-10B show a re-entry configuration for the reusable second stage 101 and the reusable and reconfigurable transporter 300 for the third example architecture of FIGS. 9A-9J according to implementations of the disclosed subject matter. FIG. 10A shows the reusable second stage 101 and the reusable and reconfigurable transporter 300 coupled to one another for re-entry into the Earth's atmosphere and/or any planetary body with an atmosphere. Attitude of the combined reusable second stage 101 and the reusable and reconfigurable transporter 300 may be controlled via the one or more fins 108 and/or by using thrust from the engines 112. The reusable second stage 101 and the reusable and reconfigurable transporter 300 coupled to one another may be oriented so that the heat shields 103 and 303 are positioned on the windward side for re-entry.

FIG. 10B shows the reusable second stage 101 and the reusable and reconfigurable transporter 300 may be separated from one another for re-entry into the Earth's atmosphere and/or any planetary body with an atmosphere. That is, the reusable second stage may be separated and may return to Earth and/or another planetary body, while the reusable and reconfigurable transporter 300 may stay in space longer before independently returning to Earth and/or another planetary body. Attitude of the reusable second stage 101 may be controlled via the one or more fins 108 and/or by thrust from the engines 112. The reusable second stage 101 may be oriented so that the heat shield 103 is positioned on the windward side (e.g., in the direction of gravity) for re-entry. The reconfigurable transporter 300 may be oriented with head shield 312 on the windward side in the direction of gravity for re-entry. The orientation of the reconfigurable transporter 300 may be controlled by ballast mass distribution and/or by operation of the propulsion system 310.

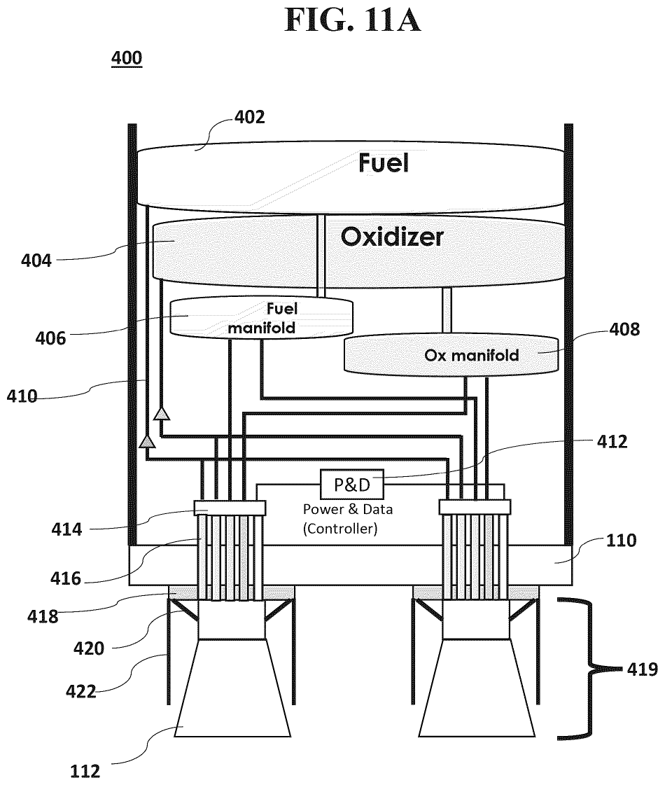

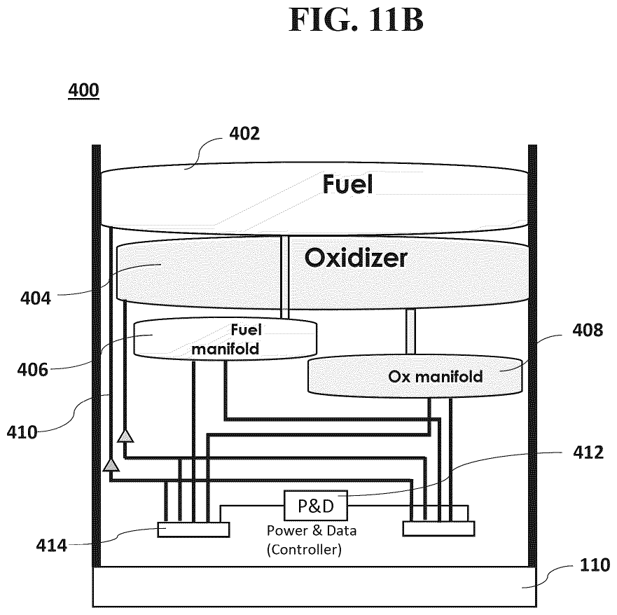

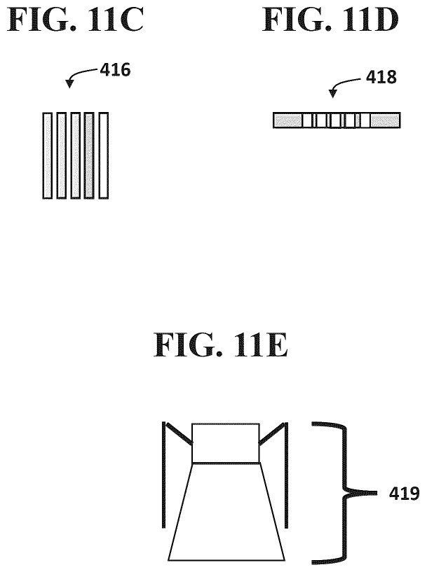

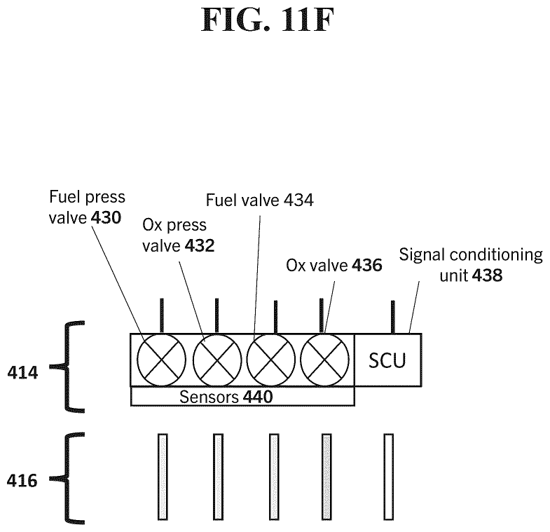

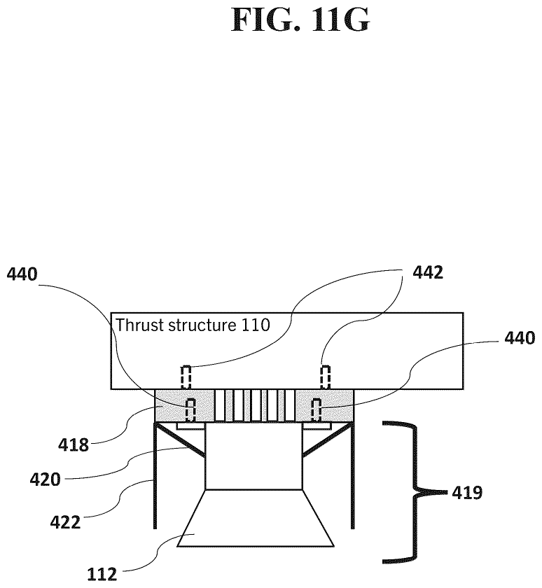

FIGS. 11A-11G show an example adaptive thrust system 400 that may include adaptive thrust structure 110 for a launch vehicle according to implementations of the disclosed subject matter. For example, the adaptive thrust system 400 and adaptive thrust structure 110 may be used for the reusable second stage 100, 101 described above. The adaptive thrust system 400 and the adaptive thrust structure 110 may accommodate different engine types (e.g., methane/liquid oxygen engines and other bi-propellant liquid rocket engines).

As shown in FIG. 11A, adaptive thrust system 400 may include fuel 402 and oxidizer 404, where fuel 402 may be similar to fuel 104 shown in FIG. 2 and discussed above, and oxidizer 404 may be similar to oxidizer 106 shown in FIG. 2 and discussed above. Fuel 402 may be fluidically coupled to fuel manifold 406, and oxidizer 404 may be fluidically coupled to oxidizer manifold 408. Autogenous pressure lines 410 may be fluidically coupled between fuel 402 and oxidizer 404, and interface block 414. Hot propellants from the engines 112 may be fed back to the tanks for fuel 402 and oxidizer 404 to keep them pressurized by using the autogenous pressure lines 410.

Adapter lines 416 may be coupled to interface block 414, may pass through adapter plate 418, and may be fluidically coupled to engines 112. The adapter lines 416 may provide fuel from the fuel manifold and oxidizer from the oxidizer manifold to the engines 112, and may be coupled to the autogenous pressure lines 410 to provide hot propellants from the engines back to the tanks for the fuel 402 and the oxidizer 404.

Engine assembly 419 may include engine 112, thrust vector control actuator arm 420, and engine shield 422. Engine assembly 419 may be coupled to adapter plate 418, which may be coupled to thrust structure 110. Controller 412 may transmit control signals to actuate thrust vector control actuator arm 420, which may adjust engine 112 to control the vector of thrust. Controller 412 may transmit control signals to control a thrust magnitude of engine 112, and/or to control the shutting off or restarting of the engine 112. Engine shield 422 may be configured to protect one or more components of the reusable second stage 100, 101 and/or the adaptive thrust structure 110 from heat generated by the engine 112. Engine shield 422 may be configured to reduce the effects of high temperatures by redirecting, absorbing, or reflecting the heat generated by the engine 112. Engine shield 422 may act as a blast shield if engine 112 fails and explodes during operation.

The controller 412 may be configured to accommodate different engine types, where control signals may be output by the controller 412 based on the selected engine type. Controller 412 may be configured to control power and/or data to interface block 414 for operation of the engine assembly 419.

FIG. 11B shows a “neutral” configuration of the adaptive thrust system 400 disposed on the adaptive thrust structure 110, where the neutral configuration of the adaptive thrust system 400 may include fuel 402, oxidizer 404, fuel manifold 406, oxidizer manifold 408, autogenous pressure lines 410, controller 412, and interface block 414. The neutral configuration of the adaptive thrust system 400 shown in FIG. 11B may be combined with engine-specific components, which may be components that may be based on a selected engine type, which may differ based on the type of engine selected. The adapter lines 416 shown in FIG. 11C and the adapter plate 418 shown in FIG. 11D may be selected based on the engine assembly 419 (e.g., as shown in FIG. 11E) that is chosen. The adaptive thrust system 400 shown in FIG. 11A may be an example of the combination of the “neutral” configuration shown in FIG. 11B, and the adapter lines 416 shown in FIG. 11C, the adapter plate 418 shown in FIG. 11D, and the engine assembly 419 shown in FIG. 11E.

FIG. 11F shows a detailed view of the interface block 414 and the adapter lines 416 of the adaptive thrust system 400. The interface block 414 may include main flow values that may include fuel press valve 430, oxidizer press valve 432, fuel valve 434, oxidizer valve 436, signal conditioning unit 438, and/or sensors 440. These valves may be the main flow valves for fuel and oxidizer for each engine (e.g., engine 112). For example, these valves may be configured for throttling the engine 112, and/or may operate as open/close flow control devices when a selected engine assembly has its own throttling valves. The main flow valves may be configured for gaseous propellants used to pressurize propellant tanks (e.g., “autogenous pressurization” of the fuel 402 and/or oxidizer 404 tanks).

The sensors 440 of the interface block 414 may include, for example, temperature and/or pressure sensors to monitor propellant flows through the interface block 414.

The signal conditioning unit 438 of the interface block 414 may be configured to adjust incoming voltage and/or current levels to for an operating condition of the engine assembly 419. Similarly, control signals received from a flight computer of the reusable second stage 100, 101 and/or reusable and reconfigurable transporter 200, 220, 240, 250, 260, 280, and/or 300 may be transmitted ‘as-is’ or may be adapted to be compatible with the specific engine type using an FPGA (field programmable gate array), PLD (programmable logic device), ASIC (application specific integrated circuit), and/or similar programmable device and/or by using active electronic components, such as operational amplifiers and/or voltage regulators. These devices may also include control logic for the fuel and/or oxidizer valves (e.g., the fuel press valve 430, oxidizer press valve 432, fuel valve 434, and/or oxidizer valve 436).

Adapter lines 416 may be engine specific and may include fuel and oxidizer lines with suitable fittings on both ends. A power and data harness with suitable connectors may be included with the adapter lines 416.

The adapter plate 418 may have mounting points 440 to mount the engine assembly 419, and may have feed-through for the adapter lines 416 (e.g., that may include fluid lines and/or the power and data harness). The adapter plate 418 may be fastened to the thrust structure 110 at mounting points 442.

The adaptive thrust system 400 and adaptive thrust structure 110 shown in FIGS. 11A-11G improves upon related art engine systems by accommodating different engine types, and the controller 412 and/or the signal condition unit 438 may be configured to output control signals to control the selected engine type. The controller 412 may provide power and/or data signals to control the engine assembly 419. Traditional engine systems cannot be changed to different types without modifications to the thrust structure, and engine control signals are configured to serve only a single engine type. That is, the engine assembly 419, the adapter lines 416, and the adapter plate 418 may be replaced with a different engine assembly, adapter lines, and adapter plate, and may be usable with existing controller 412 and interface block 414.

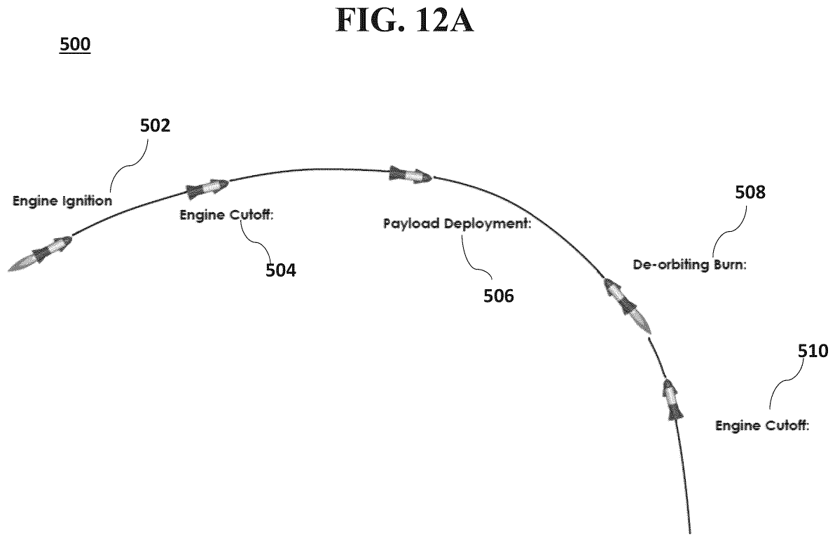

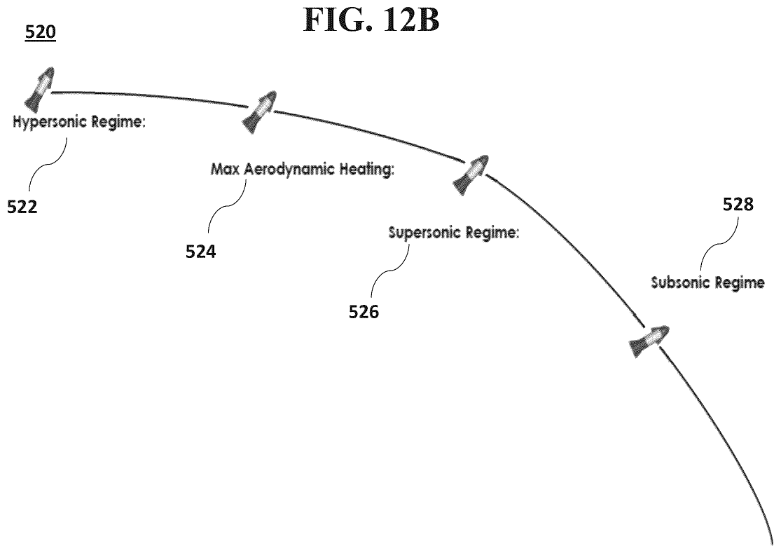

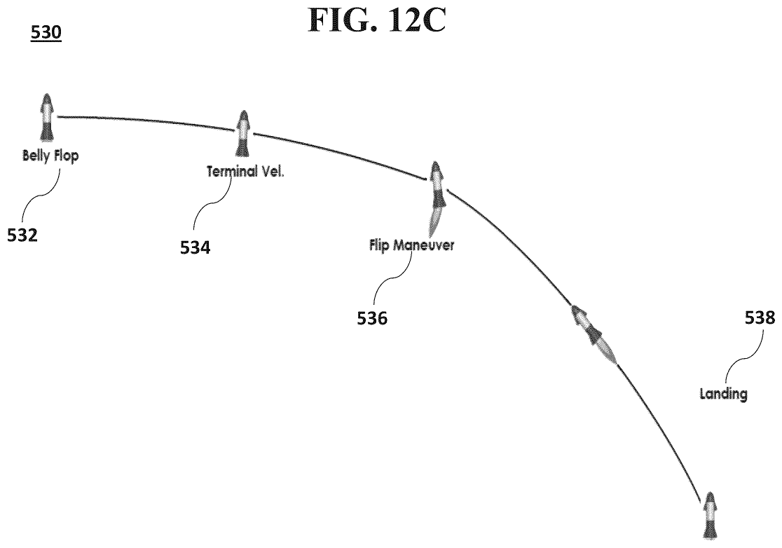

FIGS. 12A-12C show example spaceship trajectories (e.g., for reusable second stage 100, 101 and/or reusable and reconfigurable transporter 200, 220, 240, 250, 260, 280, and/or 300) according to implementations of the disclosed subject matter. At stage 502 of the trajectory 500 shown in FIG. 12A, the engines (e.g., engines 112) of the reusable second stage 100, 101 may be ignited. At stage 504, the engines of the reusable second stage 100, 101 may be stopped, and a payload (e.g., one or more satellites) may be deployed at stage 506. At stage 508, the engines 112 of the reusable second stage 100, 101 may perform a de-orbiting burn before being stopped at stage 510.

FIG. 12B shows re-entry trajectory 520 that includes a hypersonic stage 522 (e.g., where the reusable second stage 100, 101 and/or reusable and reconfigurable transporter 200, 220, 240, 250, 260, 280, and/or 300 is in hypersonic flight), a maximum aerodynamic heating stage 524 (e.g., where the reusable second stage 100, 101 and/or reusable and reconfigurable transporter 200, 220, 240, 250, 260, 280, and/or 300 experiences the maximum amount of heat generated from re-entry to the Earth's atmosphere and/or any planetary body with an atmosphere), a supersonic stage 526 (e.g., where reusable second stage 100, 101 and/or reusable and reconfigurable transporter 200, 220, 240, 250, 260, 280, and/or 300 is in supersonic flight), and a subsonic stage 528 (e.g., where reusable second stage 100, 101 and/or reusable and reconfigurable transporter 200, 220, 240, 250, 260, 280, and/or 300 is in sub-sonic flight). FIG. 12C shows a re-entry trajectory 530 that may include belly flop stage 532 (e.g., which may orient the reusable second stage 100, 101 and/or reusable and reconfigurable transporter 200, 220, 240, 250, 260, 280, and/or 300 so that the windward size is in the direction of incoming air flow during re-entry to the Earth's atmosphere and/or any planetary body with an atmosphere), a terminal velocity stage 534 (e.g., which may be a terminal velocity experienced by the reusable second stage 100, 101 and/or reusable and reconfigurable transporter 200, 220, 240, 250, 260, 280, and/or 300 in the re-entry trajectory), a flip maneuver stage 536 (e.g., which may orient the reusable second stage 100, 101 and/or reusable and reconfigurable transporter 200, 220, 240, 250, 260, 280, and/or 300 into an upright position for landing), and landing stage 538.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. An adaptive thrust structure for a space launch vehicle, comprising:
a fuel supply fluidically coupled to a fuel manifold;
an oxidizer supply fluidically coupled to an oxidizer manifold;
an interface block fluidically coupled to the fuel supply, the fuel manifold, the oxidizer supply, and the oxidizer manifold;
a first adapter plate coupled to the first engine assembly, wherein the first engine assembly is configured to provide thrust for the space launch vehicle; and
first adapter lines fluidically coupled to the first engine assembly and the interface block, via the first adapter plate,
wherein a second engine assembly is capable of replacing the first engine assembly, second adapter lines are configured to be fluidically coupled to the second engine assembly and are capable of replacing the first adapter lines, and a second adapter plate is configured to be coupled to the second engine assembly and are capable of replacing the first adapter plate.

2. The system of claim 1, further comprising a controller configured to provide control signals to the interface block to control the first engine assembly or the second engine assembly.

3. The system of claim 1, further comprising at least one engine shield configured for at least one selected from the group consisting of: the first engine assembly, and the second engine assembly.

4. The system of claim 1, further comprising at least one thrust vector control actuator arm to adjust a thrust vector of at least one selected from a group consisting of: the first engine assembly, and the second engine assembly.

5. A system comprising:
a reusable and reconfigurable launch vehicle comprising:
a reusable second stage comprising a first thrust structure coupled to a first engine assembly that is configured to provide thrust for the launch vehicle, and at least one fuel supply and at least one oxidizer supply fluidically coupled to the first engine assembly, wherein the reusable second stage is capable of being removably coupled to a reusable first stage; and
a reusable and reconfigurable transporter configured to be removably coupled to the reusable second stage, wherein the reusable and reconfigurable transporter has a plurality of zones that are configurable to transport at least one selected from a group consisting of: cargo, one or more passengers, and one or more satellites.

6. The system of claim 5, further comprising a reusable first stage comprising a second thrust structure coupled to a second engine assembly to provide thrust and at least one second propellant supply fluidically coupled to the second engine assembly, wherein the reusable first stage is configured to be removably coupled to the reusable second stage.

7. The system of claim 5, wherein the reusable and reconfigurable transporter is configured to comprise at least one selected from a group consisting of: a first transporter configured to transport the one or more satellites; a second transporter configured to transport the cargo and the one or more satellites; and a third transporter configured to transport the one or more passengers, the cargo, and the one or more satellites.

8. The system of claim 7, wherein the one or more satellites comprises a plurality of satellites and wherein the first transporter comprises:
a first zone of the plurality of zone configured to transport at least a first satellite of the plurality of satellites having a first size; and
a second zone of the plurality of zones configured to transport at least a second satellite of the plurality of satellites having a second size, wherein the first size of the first satellite is smaller than the second satellite of the second size, and
wherein the first zone is coupled to the second zone.

9. The system of claim 8, wherein the first zone comprises a door and a payload deployment structure configured to deploy at least the first satellite from the first transporter.

10. The system of claim 7, wherein the one or more satellites comprises a plurality of satellites and wherein the second transporter comprises:
a first zone of the plurality of zones configured to transport at least one selected from a group consisting of: at least one of a first satellite of the plurality of satellites having a first size, and a first cargo;
a second zone of the plurality of zones configured to transport at least a second satellite of the plurality of satellites having a second size, wherein the first size of the first satellite is smaller than the second satellite of the second size; and
a third zone of the plurality of zones configured to transport a second cargo,
wherein the first zone is coupled to the second zone and the third zone.

11. The system of claim 10, wherein the first zone comprises a door and a payload deployment structure configured to deploy at least the first satellite from the second transporter.

12. The system of claim 10, wherein the third zone includes a docking adaptor configured to be coupled to a space station.

13. The system of claim 7, wherein the third transporter comprises:
a first zone of the plurality of zones configured to transport the at least one satellite;
a second zone of the plurality of zones configured to include at least one selected from a group consisting of: a first crew module configured to transport the one or more passengers, and an escape pod; and
a third zone of the plurality of zones configured to include a second crew module configured to transport the one or more passengers,
wherein the first zone is coupled to the third zone, and the second zone is coupled to the third zone.

14. The system of claim 13, wherein the second zone is configured to include at least one selected from a group consisting of: life support systems for the one or more passengers, a propellant supply fluidically coupled to one or more engines that are configured to initiate a separation from the third zone, a docking adaptor configured to be coupled to at least a space station, and cargo.

15. The system of claim 13, wherein the third zone is configured to include life support systems for the one or more passengers.

16. The system of claim 7, wherein the first transporter comprises a plurality of fairings, each disposed on a respective linkage, wherein each of the plurality of fairings are configured to be moveable on the linkages into a position for deployment of the one or more satellites stored in the first transporter.

17. The system of claim 16, wherein the one or more satellites comprises a plurality of satellites, and wherein the first transporter is configured to transport the plurality of satellites coupled to one or more rings.

18. The system of claim 17, wherein the one or more rings comprises a plurality of rings, and the plurality of rings are arranged in a stack.

19. The system of claim 7, wherein the second transporter comprises a plurality of fairings, each disposed on a respective linkage, wherein each of the plurality of fairings are configured to be moveable on the linkages from a first position to a second position for deployment of the one or more satellites stored in a first zone the second transporter.

20. The system of claim 19, wherein the second transporter comprises a second zone configured to transport one or more satellites, and a third zone configured to transport cargo.

21. The system of claim 19, wherein the cargo transporter comprises a docking adaptor configured to be coupled to at least a space station to access the cargo when the plurality of fairings are moved into the second position.

22. The system of claim 7, wherein the third transporter comprises:
a first zone of the plurality of zones configured to transport at least a first satellite;
a second of the plurality of zones zone configured as a passenger transporter; and
a third zone of the plurality of zones configured to transport cargo and passengers.

23. The system of claim 22, wherein the third transporter comprises a plurality of fairings, each disposed on a respective linkage, wherein each of the plurality of fairings are configured to be moveable on the linkages from a first position to a second position for deployment of the passenger transporter.

24. The system of claim 22, wherein the passenger transporter includes a docking adaptor configured to be coupled to a space station when the passenger transporter is deployed.

25. The system of claim 22, wherein the third zone includes a docking adaptor configured to be coupled to at least one selected from a group consisting of: the passenger transporter, and a space station.

26. The system of claim 5,
wherein the reusable second stage further comprises a first zone of the plurality of zones configured to transport at least one first satellite of a plurality of satellites having a first size, and
wherein the first zone comprises a payload door that is configured to open to deploy the at least one satellite.

27. The system of claim 26, wherein the reusable and reconfigurable transporter comprises:
a second zone of the plurality of zones that is configured to be separable from the first zone,
wherein the second zone is configured as a passenger transporter that includes at least one selected from a group consisting of: a propulsion system, a heat shield, life support systems, and an access door that includes a docking adaptor.

28. The system of claim 26, wherein the reusable and reconfigurable transporter comprises:
a second zone of the plurality of zones configured to transport cargo; and
a third zone of the plurality of zones that is configured to transport at least one second satellite of the plurality of satellites having a second size, wherein the second size of the at least one second satellite is smaller than the first size of the at least one first satellite.

29. The system of claim 28, wherein the reusable and reconfigurable transporter comprises at least one selected from a group consisting of: a deployment rack for the at least one second satellite disposed in the third zone, and a docking adaptor disposed in the second zone that is configured to interface with a space station.
